(19) United States
(12) Patent Application Publication
(10) Pub. No.: US 2005/0214435 A1
(43) Pub. Date: Sep. 29, 2005

(54) Vegetable fat and use thereof in food preparations

(76) Inventors: Pascal DesBois, Janze (FR); Jean-Marie LaPlanche, Saint Maur Des Fosses (FR)

Correspondence Address: WIGGIN AND DANA LLP;ATTENTION: PATENT DOCKETING, ONE CENTURY TOWER, P.O. BOX 1832, NEW HAVEN, CT, 06508-1832, US

(21) Appl. No.: 10/518,781

(22) PCT Filed: Jun. 23, 2003
(86) PCT No.: PCT/FR03/01923

§ 371 Date: May 31, 2005

(30) Foreign Application Priority Data
Jun. 24, 2002 (FR) 02/07801

(51) Int. Cl. A23D 7/00

(52) U.S. Cl. 426/601

(57) ABSTRACT

The invention concerns a vegetable fat and its use in food preparations. The vegetable fat is characterized in that at least 90% of the fatty acids it contains are fatty acids with 16 to 18 carbon atoms, in that it comprises 12 to 18% of linoleic acid relative to the total fatty acids and in that it has a water content less than 0.4% of the total weight.

The present, invention relates to a vegetable fat, to the use thereof in food preparations, to the method for obtaining food products from this fat and to the food products obtained by means of these fats.

The nature of ingested dietary fats may have an influence on blood lipid, levels. A diet that is too rich in fats may cause an increase in triglyceride and cholesterol levels. Now, although a sufficient amount of cholesterol is necessary in order to remain in good health, an excess of cholesterol is unquestionably harmful and constitutes a risk factor for cardiovascular diseases (in particular through processes of narrowing of the arteries). The excess cholesterol may be due to a poor diet containing too many fats, and in particular saturated fatty acids. The role of fats in cardiac conditions is also, today, well known.

Fatty acids are the main constituents of lipids that are needed by our body. About forty natural fatty acids exist which differ from one another by virtue of their length and their degree of saturation (i.e. double bonds between carbon atoms within the carbon atom chain). The following are thus distinguished:
Saturated fatty acids that are mainly found in animal fats such as butter and in certain plant fats such as palm; these fatty acids comprise no double bond. They contribute to increasing blood cholesterol.
Monounsaturated fatty acids, the most well known of which is oleic acid (C18:1, n-9) found, inter alia, in olive oil and rapeseed oil. This fatty acid is known to decrease “bad cholesterol” or LDL cholesterol (low density lipoproteins) without reducing the “good cholesterol” or HDL cholesterol (high density lipoproteins).
Polyunsaturated fatty acids, the most important of which are linoleic acid (C18:2, n-6) and linolenic acid (C18:3, n-3), comprise a minimum of two double bonds. These two fatty acids are essential to the organism, which is not capable of producing them, and are therefore to be found in the diet. The main source of these essential fatty acids remains oil-yielding plants and the derived vegetable oils. Linoleic acid (of the omega-6 family) is known to decrease LDL cholesterol, and linolenic acid (of the omega-3 family) allows, inter alia, the synthesis of derivatives that contribute to blood fluidity in the context of a balanced diet.

To reduce the risks of vascular accidents, there must be sufficient amounts of polyunsaturated fatty acids and monounsaturated fatty acids in the diet. In addition, it would be preferable to maintain a ratio of omega-6 fatty acids to omega-3 fatty acids of close to 2:1 (current diet being rather at a ratio of 10:1 to 20:1). Furthermore, the importance of vegetable-based food in preventing cardiovascular diseases and cancers is becoming clearer. Soybean-based products, for example, once included in diets low in cholesterol and low in saturated fats, can in fact reduce the risk of coronary artery diseases.

Products rich in saturated fatty acids potentially prejudicial to the health are, however, commonly used in agrofoods. This is the case, for example, of palm oil, or of hard vegetable fats which have undergone physical modifications and which, as a result of these treatments, contain trans fatty acids (i.e. fatty acids generated by partial hydrogenation). These fatty acids are of artificial origin and occur very little, in the natural state, in foods, except in the case of animal fats. These trans fatty acids act in the same way as saturated fatty acids on the mechanism of development of lipid-related diseases which can result in cardiovascular diseases and strokes.

A subject of the present invention is a vegetable fat having a composition liable to prevent cardiovascular diseases in the context of a balanced diet, by providing the essential fatty acids of the omega-6 and omega-3 family, that are precursors of the highly polyunsaturated fatty acids EPA (eicosapentaenoic acid) and DHA (docosahexaenoic acid).

A subject of the invention is also a vegetable fat that is solid at ambient temperature, and that has a saturated fatty acid content that is decreased by half compared with the fats such as palm oil normally used.

Another subject of the invention is the use of this fat in the formulation of food preparations, and in particular in sponge cakes or cereal bars, and any other food product produced using a fat.

The invention is particularly advantageous for preparing cereal bars, or sponge cakes such as brownies or madeleines.

Another subject of the invention is a food product, as defined above, produced using a fat according to the invention.

A subject of the invention is also a method for preparing a food product of the type defined above, using at least one fat according to the invention.

Other subjects will emerge on reading the description and the examples which follow.

It has been discovered that it is possible to obtain these advantageous results by means of the vegetable fat according to the invention in which at least 90% of the fatty acids that it comprises are fatty acids with 16 to 18 carbon atoms, which comprises from 12 to 18% of linoleic acid relative to the total fatty acids, and the water content of which is less than 0.4% of the total mass.

In a preferred embodiment, the fat according to the invention comprises from 25 to 30% of saturated fatty acids relative to the total fatty acids, from 45 to 60% of monounsaturated fatty acids relative to the total fatty acids, and from 10 to 30% of polyunsaturated fatty acids relative to the total fatty acids.

The fat according to the invention is not affected by cooking and keeps its initial composition without developing trans fatty acids.

The fat thus comprises less than 1% of trans fatty acids, i.e. partially hydrogenated trans fatty acids.

In a preferred embodiment, the fat comprises less than 0.3% of trans fatty acids.

The fat according to the invention may comprise fatty acids of the omega-3 and omega-6 families. In a preferred embodiment, the fat may comprise in particular, among the polyunsaturated fatty acids that it contains, from 3 to 7% of linolenic acid relative to the total fatty acids. This then gives an omega-6/omega-3 ratio of less than 7:1, which is a very favourable ratio compared with that of current food.

In accordance with the invention, when reference is made to fatty acids, it is understood that they are in the form of triglycerides.

The fat according to the invention may advantageously have the following characteristics:

Fatty acid composition of the vegetable fat according to the invention:

| | |
|---|---|
| C12:0 | 0.1-0.3% |
| C14:0 | 0.4-0.6% |
| C16:0 | 22-26% |
| C18:0 | 2.5-4% |
| C18:1, n-9 | 47-51% |
| C18:2, n-6 | 12-18% |
| C18:3, n-3 | 3-7% |
| C20:0 | 0.5-0.8% |
| C20:1 | 0.7-1% |
| C20:2 | 0.05-1.5% |
| C22:0 | 0.2-0.5% |

The water content of the fat according to the invention is less than 0.4%. The fat according to the invention contains virtually no proteins, carbohydrates or salt.

The fat according to the invention is of vegetable origin, which avoids trans fatty acid intake. In particular, the fat contains palm oil, as it is or fractionated, and rapeseed oil, the relative proportions of which are 30:70 to 50:50, and preferably 40:60.

The fat according to the invention can also contain vitamins (liposoluble vitamins such as vitamins A and E), emulsifiers (fatty acid monoglycerides and diglycerides, lecithins, etc.), dyes (carotene, marigold extract, etc.), salt and also flavourings, without modification of its properties.

The fat which is the subject of the invention is solid at ambient temperature but malleable, and has a melting point of between 35 and 45° C.

The fat is used in the formulation of food products, such as sandwich breads, patisserie products, cereal bars, Viennese pastries, sponge cakes, or other applications (creaming, etc.). The fat can be involved in day-to-day nutrition and can actively contribute to the prevention of cardiovascular diseases.

The following examples are, intended to illustrate the invention without, however, being limiting in nature.

### EXAMPLE 1

### Formulation of a Fat According to the Invention

This fat is a mixture of 40% of palm oil and of fractionated palm oil with 59.76% of rapeseed oil, of 0.2% of fatty acid monoglycerides and diglycerides originating from palm, and of 0.04% of vitamin E (tocopherol).

### EXAMPLE 2

### Determination of the Melting Point of the Fat According to the Invention

These measurements were carried out by low-resolution NRM (nuclear magnetic resonance) on a fat of formulation as in example 1.

The melting point is defined as the temperature at which there is no longer any fat in solid form in the sample under consideration. The sliding point is defined as the temperature range in which the fat begins to melt.

| | Temperature in ° C. | | | | | |
|---|---|---|---|---|---|---|
| | 15 | 20 | 25 | 30 | 35 | 40 |
| Fat in solid form (as %) | 16 to 20 | 12 to 15 | 9 to 11 | 7 to 9 | 5 to 7 | 0 |

The melting point of this fat is thus 40° C. with a sliding point of between 30 and 35° C. This fat is therefore malleable and sufficiently solid to be plastic at ambient temperature.

The fat according to the invention is used to prepare food products, products for which some of the recipes are indicated hereinafter. The distributions of the fatty acids present in the products developed based on the fat according to the invention are compared with those obtained in products that come from using standard recipes.

### EXAMPLE 3

### Sweet Pastry

A pastry is prepared according to the following recipe:

| | | Product according |
|---|---|---|
| | Standard product | to the invention |
| Ingredients | (amount in grammes) | (amount in grammes) |
| flour | 49.0 | 49.0 |
| sugar | 19.6 | 19.6 |
| Product according | — | 19.6 |
| to example 1 | | |
| nonhydrogenated | 19.6 | — |
| palm | | |
| eggs | 11.8 | 11.8 |
| TOTAL | 100 | 100 |

The results obtained after cooking are:

| | |
|---|---|
| | Product according |
| Standard product | to the invention |

| Type of | In g/100 g of | | In g/100 g | |
|---|---|---|---|---|
| fatty | finished | In | of finished | In |
| acids | product | relative % | product | relative % |
| SFA | 10.5 | 47.9 | 5.3 | 28.3 |
| MUFA | 8.8 | 40.3 | 9.0 | 48.1 |
| PUFA | 2.6 | 11.8 | 4.4 | 23.6 |

SFA: saturated fatty acids

MUFA: monounsaturated fatty acids

PUFA: polyunsaturated fatty acids

Thus, in a standard product, the PUFA represent 11.8% of the fats used in the recipe, whereas a sweet pastry prepared with the fat according to the invention comprises more than 23% thereof.

### EXAMPLE 4

### Patisserie Products of the Brownies Type

A dough is prepared according to the following recipe:

| | | Product according |
|---|---|---|
| | Standard product | to the invention |
| Ingredients | (amount in grammes) | (amount in grammes) |
| Cocoa powder | 2 | 2 |
| Dark chocolate | 2.5 | 2.5 |
| Salt | 0.2 | 0.2 |
| Sugar | 32 | 32 |
| Flour | 16 | 16 |
| Water | 13 | 13 |
| Eggs | 11 | 11 |
| Flavouring | 0.3 | 0.3 |
| Product according | — | 23 |
| to example 1 | | |
| Nonhydrogenated | 23 | — |
| palm | | |
| TOTAL | 100 | 100 |

The results obtained after cooking are:

| | |
|---|---|
| | Product according |
| Standard product | to the invention |

| Type of | In g/100 g of | | In g/100 g | |
|---|---|---|---|---|
| fatty | finished | In | of finished | In |
| acids | product | relative % | product | relative % |
| SFA | 12.8 | 48.1 | 6.0 | 28.2 |
| MUFA | 10.7 | 40.2 | 10.3 | 48.1 |
| PUFA | 3.1 | 11.7 | 5.1 | 23.7 |

In the recipe prepared with the vegetable fat according to the invention, it is seen that the proportion of PUFA is 23.7%, i.e. twice as much as in a standard recipe.

### EXAMPLE 5

### Cereal Bars

A dough is prepared according to the following recipe:

| | | Product according |
|---|---|---|
| | Standard product | to the invention |
| Ingredients | (amount in grammes) | (amount in grammes) |
| Glucose syrup | 44 | 44 |
| sugar | 17 | 17 |
| honey | 10 | 10 |
| dextrose | 8 | 8 |
| glycerol | 6 | 6 |
| emulsifier | 0.5 | 0.5 |
| water | 4.5 | 4.5 |
| Product according | — | 10 |
| to example 1 | | |
| Nonhydrogenated | 10 | — |
| palm oil | | |
| mixture of cereals | 150 | 150 |
| and fruits | | |
| TOTAL | 250 | 250 |

The results obtained after cooking of the binder and mixture with cereals and fruits are:

| | |
|---|---|
| | Product according to the |
| Standard product | invention |

| Type of | In g/100 g of | | In g/100 g | |
|---|---|---|---|---|
| fatty | finished | In | of finished | In |
| acids | product | relative % | product | relative % |
| SFA | 2.2 | 47.9 | 1.2 | 27.5 |
| MUFA | 1.8 | 39.0 | 2.0 | 47.2 |
| PUFA | 0.6 | 13.1 | 1.1 | 25.3 |

Using the vegetable fat according to the invention, the proportion of PUFA in the cereal bar thus obtained is twice that of a standard bar.

It is clearly seen, by means of these examples, that, by using the fat according to the invention in the recipes for preparing patisserie products and other Viennese pastries, an SFA/MUFA/PUFA composition that is very close to the ideal of 25/50/25 is obtained.

1. A vegetable fat, characterized in that at least 90% of the fatty acids that it comprises are fatty acids with 16 to 18 carbon atoms, in that it comprises from 12 to 18% of linoleic acid relative to the total fatty acids, and in that it has a water content of less than 0.4% of the total mass.

2. The fat as claimed in claim 1, characterized in that it comprises from 25 to 30% of saturated fatty acids relative to the total fatty acids.

3. The fat as claimed in either one of claims 1 and 2, characterized in that it comprises from 45 to 60% of monounsaturated fatty acids relative to the total fatty acids.

4. The fat as claimed in any one of claims 1 to 3, characterized in that it comprises from 10 to 30% of polyunsaturated fatty acids relative to the total fatty acids.

5. The fat as claimed in any one of claims 1 to 4, characterized in that it comprises less than 1% of trans fatty acids relative to the total fatty acids.

6. The fat as claimed in any one of claims 1 to 5, characterized in that it comprises less than 0.3% of trans fatty acids relative to the total fatty acids.

7. The fat as claimed in any one of claims 1 to 6, characterized in that it comprises from 3 to 7% of linolenic acid relative to the total fatty acids.

8. The fat as claimed in any one of claims 1 to 7, characterized in that the ratio of omega-6 fatty acids to omega-3 fatty acids is less than 7.

9. The fat as claimed in any one of claims 1 to 8, characterized in that it contains, optionally fractionated palm oil and rapeseed oil.

10. The fat as claimed in any one of claims 1 to 9, characterized in that the palm oil and the rapeseed oil are in respective proportions of between 30:70 and 50:50.

11. The fat as claimed in any one of claims 1 to 10, characterized in that it comprises vitamins, emulsifiers, salt, dyes or flavourings.

12. The fat as claimed in any one of claims 1 to 11, characterized in that its melting point is between 35° C. and 45° C.

13. The use of a fat as claimed in any one of claims 1 to 12, in the formulation of a food product.

14. A food product, characterized in that it is produced using a fat as claimed in any one of claims 1 to 13.

15. The product as claimed in claim 14, characterized in that it is a sponge cake or a cereal bar.

16. A method for preparing a food product, characterized in that it uses at least one fat as claimed in any one of claims 1 to 12.
